(19) United States
(12) Patent Application Publication
(10) Pub. No.: US 2003/0128736 A1
(43) Pub. Date: Jul. 10, 2003

(54) Turbine component inspection system

(76) Inventors: Brian A. Dalio, Lake Oswego, OR (US); Maurice J. Bales, Lafayette, CA (US); Dimitry S. Vladimirov, Daly City, CA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/062,638

(22) Filed: Jan. 31, 2002

Related U.S. Application Data
(60) Provisional application No. 60/339,725, filed on Nov. 1, 2001.

(51) Int. Cl. G01K 1/08

(52) U.S. Cl. 374/141

(57) ABSTRACT

A turbine component inspection apparatus includes a first pressure vessel to store and maintain a first fluid at a first temperature and pressure, a second pressure vessel to store and maintain a second fluid at a second temperature and pressure. The first and second pressure vessels are coupled to a first fluid delivery line and a second fluid delivery line. First and second pneumatically actuated valves facilitate alternating delivery of the fluid from the first and second pressure vessels. Included in the system is a turbine component inspection fluid delivery line to deliver the alternating fluids to a turbine component, a number of sensors to detect changes in temperature and pressure of the first and second fluids, and a programmable logic control (PLC) to storing and maintaining of the first and second temperatures and pressures. As a result, a precise delivery of high temperature gases to a turbine component is facilitated, independent of inspection cycles.

### RELATED APPLICATION

This patent application claims benefit of priority to provisional patent application No. 60/339,725, titled “AN IMPROVED TURBINE COMPONENT INSPECTION SYSTEM”, filed Nov. 01, 2001.

### FIELD OF THE INVENTION

The invention relates to the field of infrared (IR) inspection of turbine components, such as turbine blades, turbine vanes, and other turbine items of the like having passages and/or cooling channels for liquid or gas flows. More specifically, the invention relates to precision delivery of high temperature gas or thermal stimuli to the gas turbine components independent of inspection cycles.

### BACKGROUND OF THE INVENTION

Failure of a turbine component can be costly, and may even be catastrophic. Accordingly, manufacturing a turbine component involves precision casting and machining processes, as each of these processes may introduce variables that affect the quality of the turbine component, and in turn, its performance.

During the casting process, variables such as core misalignment, inclusions, and the like, can introduce casting defects into the turbine component. Often times, these casting defects in turn may affect the machining process, resulting in machining defects, as well. As alluded to earlier, an example of a turbine component may be a thin or flat object that may be referred to as vanes or blades utilized to cause fluid flow or direct fluid.

For example, a turbine blade may include features such as cooling channels and holes. Cooling channels are internal features of the blade through which coolants (e.g. in the form of gases) may flow. Because of the internal nature of the cooling channels, cooling channels are, often times, formed during the casting process utilizing casting cores. Defects, such as core misalignments may result in incorrectly formed or blocked cooling channels.

The cooling holes allow the coolant flowing through the blade to be exhausted out of the blade. The dimension of the cooling holes may be in the range of 10ths of millimeters. Because of the small dimension of the cooling holes, often times, the cooling holes are machined into the blade after the casting process. In order to control the precision of machining the cooling holes, an automated process may be utilized for the physical drilling of the holes, such as computerized numerically controlled (CNC) machine.

Drilling the cooling holes by CNC machine involves the CNC machine determining the exact position of the cooling holes in three-dimensional space accounting for dimensional tolerances. If casting defects, such as core misalignments, affect the dimensions of the blade to the extent that the dimensional tolerances are exceeded, the cooling holes may not be drilled properly.

Recently, inspection methods involving thermal signatures of materials, in particular, infrared (IR) detection imaging, are being utilized to inspect and detect defects in the manufacturing of turbine components. For example, a blade inspection method utilizing IR imaging involves applying a thermal differential to the blade. Often times, applying a thermal differential involves delivering a thermal stimulus, such as a gas, at a high temperature to the blade, and then, immediately following the high temperature thermal stimulus, delivering another thermal stimulus, such as the gas, at a cold temperature (i.e., cold, relative to the high temperature thermal stimulus) to the blade.

To ensure the high precision turbine blades are inspected properly, the inspection itself, including e.g. the application of the thermal differential stimuli, has to be performed with great precision, with the inspection system properly calibrated. Accordingly, a thermal inspection system with a thermal stimuli delivery arrangement having improved precision independent of inspection cycles is desired.

### BRIEF DESCRIPTION OF THE DRAWINGS

The invention is illustrated by way of example and not by way of limitation in the figures of the accompanying drawings, in which the like references indicate similar elements and in which:

FIG. 1 illustrates an exemplary object for inspection upon which one embodiment of the present invention may be practiced;

FIG. 2 illustrates an IR inspection system that facilitates delivery of gases with a high thermal differential at precisely controlled temperatures, independent of the inspection cycle, in accordance with one embodiment of the present invention; and

FIG. 3 illustrates a pressure vessel with its internal components, in accordance with one embodiment of the present invention.

### DETAILED DESCRIPTION OF THE INVENTION

In the following description, various aspects of the invention will be described. However, it will be apparent to those skilled in the art that the invention may be practiced with only some or all described aspects. For purposes of explanation, specific numbers, materials and configurations are set forth in order to provide a thorough understanding of the invention. However, it will also be apparent to one skilled in the art that the invention may be practiced without the specific details. In other instances, well-known features are omitted or simplified in order not to obscure the invention.

Various operations will be described as multiple discrete steps in turn, in a manner that is most helpful in understanding the invention. However, the order of description should not be construed as to imply that these operations are necessarily order dependent. In particular, these operations need not be performed in the order of presentation.

For the purposes of describing the present invention, flowing materials will be described as gases; however, it should be appreciated that the flowing materials may be any type of flowing materials, such as, but not limited to fluids. As will be evident in the disclosure to follow, various flowing materials, such as, but not limited to, liquid gases may also be utilized within the spirit and scope of the present invention.

In various embodiments of the present invention, an infrared (IR) inspection system that facilitates delivery of gases with a high thermal differential at precisely controlled temperatures, independent of the inspection cycle, is disclosed. This and other advantages will be evident from the disclosure.

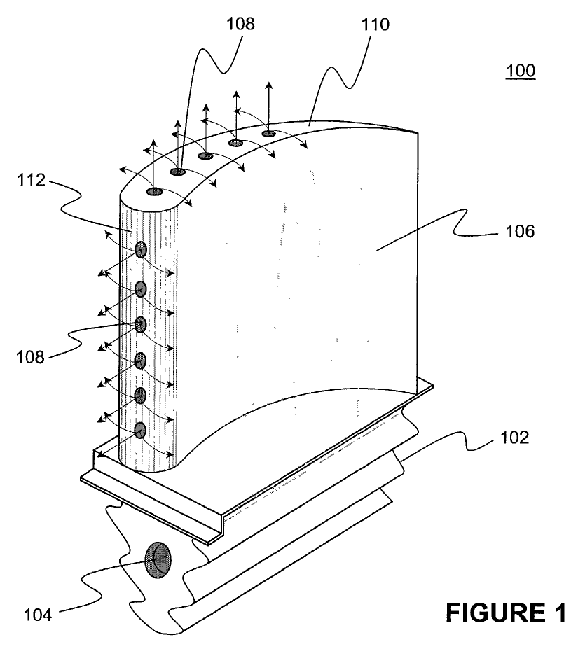

FIG. 1 illustrates an exemplary object for inspection upon which one embodiment of the present invention may be practiced. Shown in FIG. 1, the exemplary object is a turbine component, in particular, a gas turbine blade 100. The blade 100 includes a base 102 having an inlet 104 to receive an inspection medium, such as, but not limited to gas. Also shown in FIG. 1, are cooling channels 106 within the blade 100 through which the gas flows. The gas is exhausted from the blade 100 through cooling holes 108. As shown in FIG. 1, the cooling holes 108 may be on different surfaces 110 & 112 of the blade 100. Gases at different temperatures facilitate infrared (IR) detection and imaging of the various features, such as, but not limited to, internal cooling channels 106 and cooling holes 108, in accordance with one embodiment of the present invention.

In FIG. 1, the turbine component illustrated is a turbine blade, but it should be appreciated by those skilled in the relevant art that teachings of the present invention may be practiced with any high precision turbine component having features, such as, but not limited to, passages, cooling holes or channels. However, for ease of understanding, the remainder description will primarily be presented in the context of a turbine blade 100.

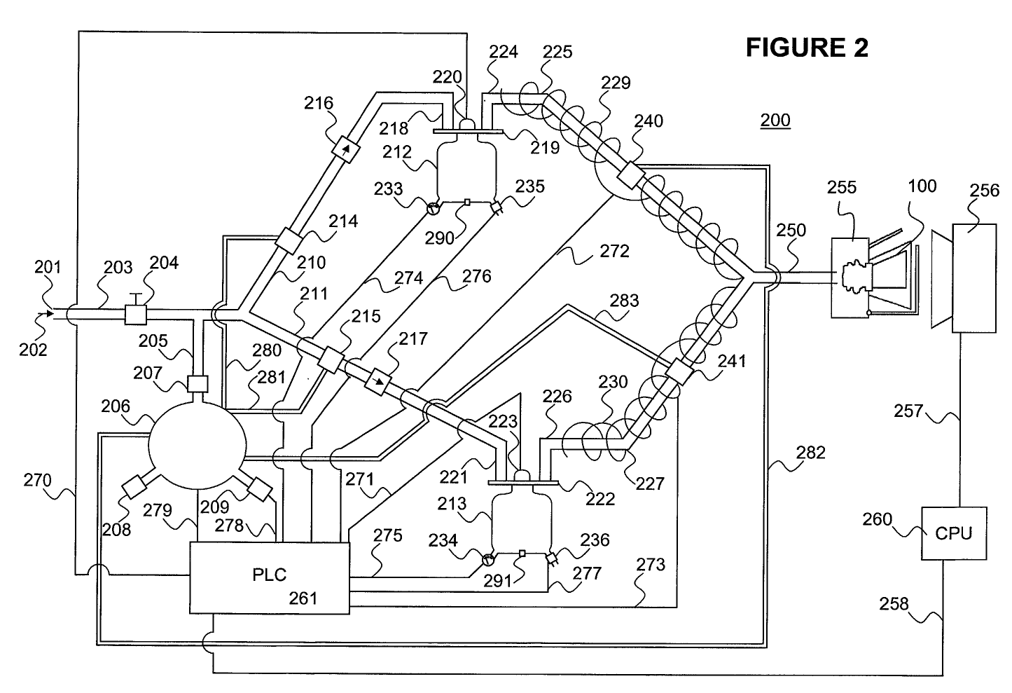

FIG. 2 illustrates an IR inspection system that facilitates delivery of gases with a high thermal differential at precisely controlled temperatures, independent of the inspection cycle, in accordance with one embodiment of the present invention. In order to aid proper understanding of the operation of the present invention, the one embodiment of the present invention shown in FIG. 2 will be first described in terms of how various components of the system are connected.

In FIG. 2, an IR inspection system 200 has a gas inlet 201 to receive gas at ambient temperature 202. For purposes of describing the present invention, the gas may be air, and the ambient temperature may be a theoretical room temperature, such as, but not limited to, 20° C. (68° F.). However, it should be appreciated by those skilled in the art that the gas may be any type of gases, such as, but not limited to, nitrogen. The theoretical room temperature may be derived when calibrating a thermometer to the Celsius scale, setting zero at the freezing point of pure water and 100° C. (212° F.) for the boiling point. Additionally, the ambient gas 202 at the inlet 201 may be gas that has been dehumidified, removing water molecules, and filtered, removing contaminant particles, such as, oil, dust, and the like.

The gas inlet 201 is part of a main gas line 203, and connected to the main gas line 203 is a regulator that receives the ambient gas 202. The regulator 204 maintains a gas pressure within the inspection system 200 at a predetermined pressure, such as, but not limited to 689.5 kPa (100 psi) relative or gage pressure (psig). The pressure of 689.5 kPa (100 psi) ensures that the gas will flow to the proper components when necessary. Thus, for the embodiment, the ambient gas 202 is at a pressure of 689.5 kPa (100 psi) just after the regulator 204.

Connected to the main gas line 203 after the regulator is a pressure vessel gas line 205 that diverts part of the gas at ambient 202 to an ambient temperature pressure vessel 206. The ambient pressure vessel 206 holds a volume of gas to control various pneumatically controlled components of the inspection system 200. In one embodiment, the volume of the ambient pressure vessel 206 may be 15-19 l (4-5 gal).

Between the ambient pressure vessel 206 and the pressure vessel gas line 205 is a manual shut-off valve 207 to prevent gas from continuing to flow into the ambient pressure vessel 206. Additionally, the ambient pressure vessel 206 includes a pressure release valve 208 and a humidity sensor 209. The pressure release valve 208 prevents the pressure within the ambient pressure vessel 206 from reaching pressures beyond the safety criteria for the particular type of pressure vessel. The humidity sensor 209 detects the amount of moisture in the air in the system 200. Furthermore, the humidity sensor 209 may be included in various locations of the IR detection system 200, but the operation of the humidity sensor 209 may be affected by high temperatures.

Beyond the pressure vessel gas line 205, the main gas line 203 splits into two gas lines, one gas line being a hot gas (HG) charge line 210 and the other being a cold gas (CG) charge line 211. The HG charge line 210 delivers ambient gas 202 to a HG pressure vessel 212. The CG charge line 211 delivers ambient gas 202 to a CG pressure vessel 213.

Immediately following the split, each of the HG charge line 210 and the CG charge line 211 is connected to a first pneumatically actuated valve (PAV) 214 and a second PAV 215 respectively. The first PAV 214 is used to control the flow of ambient gas 202 into the HG pressure vessel 212. The second PAV 215 is used to control the flow of ambient gas 202 into the CG pressure vessel 213. Also connected to each of the HG charge line 210 and the CG charge line 211, between the first PAV 214 and the HG pressure vessel 212 and also between the second PAV 215 and the CG pressure vessel 213, is a first and second check valve (CV) 216 & 217, respectively. The first CV 216 prevents HG flowing back into the HG charge line 210 from the HG pressure vessel 212. The second CV 217 prevents CG flowing back into the CG charge line 211.

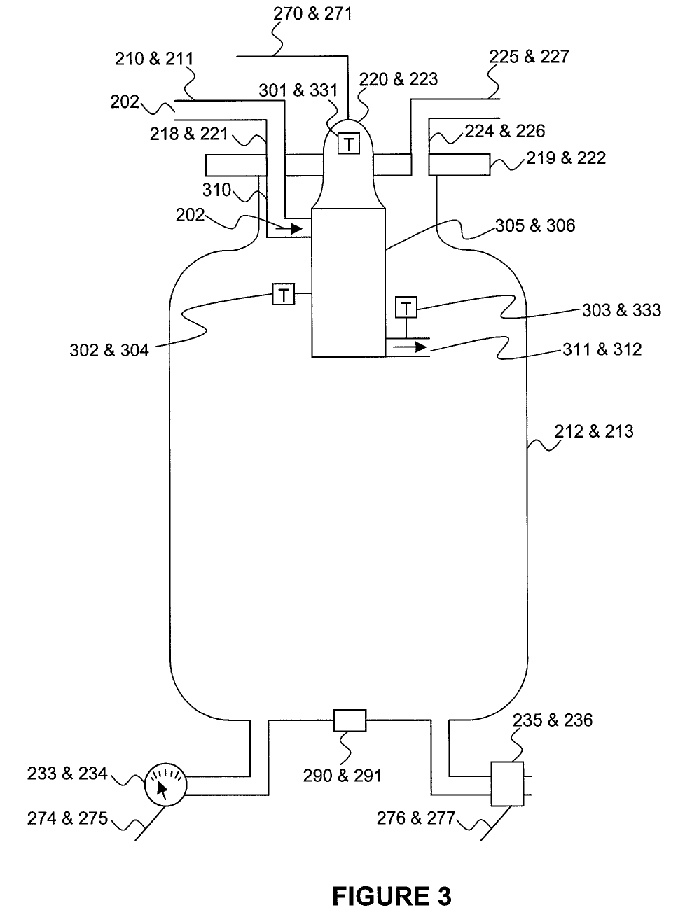

Shown in FIG. 2, the HG charge line 210 is connected to a HG pressure vessel inlet 218 on a HG pressure vessel cover plate 219, and in turn, the HG pressure vessel inlet 218 is connected to a first heat exchanger (shown as ref. 305 in FIG. 3) within the HG pressure vessel 212. Also shown on the HG pressure vessel cover plate 219 is a first electric heater 220. The first electric heater 220 is used to heat the first heat exchanger 305 to heat the HG to a predetermined temperature, such as, but not limited to 400° C. (752° F.). The first electric heater 220 may be a cartridge heater.

Also shown in FIG. 2, the CG charge line 211 is connected to a CG pressure vessel inlet 221 on a CG pressure vessel cover plate 222, and in turn, the CG pressure vessel inlet 221 is connected to a second heat exchanger (shown as ref. 306 in FIG. 3) within the CG pressure vessel 213. The CG pressure vessel cover plate 222 has a second electric heater 223. The second electric heater 223 is used to heat the second heat exchanger 306 to heat the CG to a predetermined temperature, such as, but not limited to, 50° C. (122° F.). The CG is heated to a temperature above the ambient to facilitate precise control of the temperature of the CG (i.e., ambient temperatures may vary, but the CG remains at the predetermined temperature controlled by the energy inputted to the gas). The temperature of the CG at 50° C. (122° F.) is high enough to be above a majority of ambient temperatures for production and laboratory environments. However, the thermal differential between the HG at 400° C. (752° F.) and the CG at 50° C. (122° F.) as cold is high enough to designate the CG as cold. In one embodiment, the HG and CG pressure vessels may have a capacity of 95 l (25 gal).

Furthermore, the HG pressure vessel 212 and the CG pressure vessel 213 have identical components (i.e., they both have components that heat gas). Utilizing identical components for providing both the HG and CG simplifies the IR inspection system 200 because there is no need to include a gas cooler (not shown). Having identical components for both the HG pressure vessel 212 and the CG pressure vessel 213 also facilitates interchangeability of components between the two pressure vessels 212 & 213 simplifying maintenance and testing of the system immediately after assembly.

In FIG. 2, the HG pressure vessel cover plate 219 has a HG pressure vessel outlet 224 that is connected to a HG delivery line 225. The HG delivery line 225 connects to an inspection gas delivery line 250. The CG pressure vessel cover plate 222 has a CG pressure vessel outlet 226 that is connected to a CG delivery line 227, and the CG delivery line 227 also connects to the inspection gas delivery line 250. The inspection gas delivery line 250 is connected to a blade inspection apparatus 255, which holds the gas turbine blade 100 for inspection.

Connected to the HG delivery line 225, between the HG pressure vessel outlet 224 and the inspection gas delivery line 250, is a third PAV 240 to control delivery of the HG from the HG pressure vessel 212. Connected to the CG delivery line 227, between the CG pressure vessel outlet 226 and the inspection gas delivery line 250, is a fourth PAV 241 to control delivery of the CG from the CG pressure vessel 213.

In order to control heat transfer during the flow of gas through the HG delivery line 225 and the CG delivery line 227, a first wire heater 229 is wrapped around the HG delivery line 225 and a second wire heater 230 is wrapped around the CG delivery line 227. The first wire heater 229 helps maintain the HG flowing through the HG delivery line 225 at 400° C. (752° F.), and the second wire heater 230 helps maintain the CG flowing through the CG delivery line 227 at 50° C. (122° F.).

Shown in FIG. 2, an IR camera 256 is positioned to detect the thermal signatures of the blades 100 under inspection. The IR camera data is transmitted to a central processing unit (CPU) 260 via a communication line 257, where the received data from the IR camera 256 is analyzed for generation of IR images of the blade under inspection.

The CPU 260 may also be utilized to control a programmable logic controller (PLC) 261 via a second communication line 258 from the CPU 260 to the PLC 261. The PLC 261 has a number of control lines connected to various components of the inspection system 200. In one embodiment, the PLC may be programmed with fuzzy logic to control the various components of the inspection system 200.

A first control line 270 connects the PLC 261 with the first electric heater 220 on the HG pressure vessel cover plate 219 to control the temperature of the first heat exchanger 305 (shown in FIG. 3) and maintain the proper gas temperature. Additionally, data from a temperature sensor 301 within the first electric heater and two temperature sensors 302-303 (shown in FIG. 3), located within the HG pressure vessel 212, is received by the PLC 261 to further facilitate control of the gas temperature within the HG pressure vessel 212.

A second control line 271 connects the PLC 261 with the second electric heater 223 on the CG pressure vessel cover plate 222 to control the temperature of the second heat exchanger 306 (shown in FIG. 3) and maintain the proper gas temperature. Data from a temperature sensor 331 within the second electric heater 223 and two temperature sensors 304 & 333, located within the CG pressure vessel 213, is received by the PLC 261 to facilitate control of the gas temperature within the CG pressure vessel 213.

As illustrated in FIG. 2, a third control line 272 and a fourth control line 273 each connect the PLC 261 to the first wire heater 229 and the second wire heater 230 respectively. The third and fourth control lines 272 & 273 facilitate control of the wire heaters 229 & 230 to maintain the temperatures of the HG and CG as they flow through the HG and CG delivery lines 225 & 227.

A fifth control line 274 connects the PLC 261 with a first pressure sensor 233 on the HG pressure vessel 212, and a sixth control line 275 connects the PLC 261 with a second pressure sensor 234 on the CG pressure vessel 213. The fifth and sixth control lines 274 & 275 receive data from first and second pressure sensors 233 & 234.

A seventh control line 276 connects the PLC 261 with a first solenoid valve 235 on the HG pressure vessel 212, and an eighth control line 277 connects the PLC 261 with a second solenoid valve 236 on the CG pressure vessel 213. The seventh and eighth control lines 276 & 277 open and close the first and second solenoid valves 235 & 236 to relieve pressure within each of the pressure vessels 212 & 213.

A ninth control line 278 connects the PLC 261 with the humidity sensor 209 to receive data regarding the humidity in the gas. The data regarding the humidity in the gas may be used to control a dehumidifier (not shown) before the gas enters the gas inlet 201. Additionally, the data may be stored to facilitate calculations of energy delivered to the gas turbine blade 100 (shown in FIG. 1) because small variations in humidity may affect the retention of thermal energy by the gas turbine blade 100 and transfer of thermal energy from the CG and the HG.

A tenth control line 279 connects the PLC 261 with the ambient temperature pressure vessel 206 to control the opening and closing of the PAVs 214-215 & 240-241. In order to facilitate the opening and closing of the PAVs 214-215 & 240-241, a number of pneumatic control lines connect the ambient temperature pressure vessel 206 with the number of PAVs 214-215 & 240-241.

A first pneumatic control line 280 connects the ambient temperature pressure vessel 206 with the first PAV 214. A second pneumatic control line 281 connects the ambient temperature pressure vessel 206 with the second PAV 215. A third pneumatic control line 282 connects the ambient temperature pressure vessel 206 with the third PAV 240. Finally, a fourth pneumatic control line 283 line connects the ambient temperature pressure vessel 206 with the fourth PAV 241.

As a result, the combination of the various components shown in FIG. 2 facilitates delivery of gases with a high thermal differential at precisely controlled temperatures, independent of the inspection cycle, in accordance with one embodiment of the present invention.

Before an inspection cycle, initial settings are provided to the inspection system 200. The initial settings include charging the HG pressure vessel 212 with gas until the temperature of the gas reaches 400° C. (752° F.) and the pressure reaches 552 kPa (80 psi) within the HG pressure vessel 212. The CG pressure vessel 213 is also charged with gas at a temperature of 50° C. (122° F.) and also a pressure of 552 kPa (80 psi). The electric heaters 220 & 223 are heated to their appropriate temperatures to ensure that the heat exchangers 305 & 306 (shown in FIG. 3) provide the gas into their respective pressure vessels 212 & 213 at the predetermined temperatures. Additionally, the wire heaters 229 & 230 are provided enough energy to heat the delivery lines 225 & 227 at the predetermined temperatures (i.e., HG delivery line 225 at 400° C. (752° F.) and the CG delivery line 227 at 50° C. (122° F.). Additionally, all of the PAVs 214-215 & 240-241 are closed. Once the initial settings are provided, a gas turbine blade 100 may be inspected using the inspection system 200, in accordance with one embodiment of the present invention.

During an inspection cycle, the third PAV 240 is opened allowing HG at 400° C. (752° F.) to flow from the HG pressure vessel 212 to the inspection gas delivery line 250. The HG flows into the inlet 104 of the base 102 of the blade 100 and flows through the cooling channels 106 to be exhausted out of the cooling holes 108. The quantity of the HG delivered to the blade 100 is predetermined and based at least upon the particular type of blade.

Because of the high temperature of the HG, common flow meters may be damaged, and therefore, the quantity of HG delivered to the blade is determined by applying the principles of the Ideal Gas Law. When the first pressure sensor 233 transmits data to the PLC 261 corresponding to a pressure within the HG pressure vessel 212 at 552 kPa (80 psi), the PLC 261 receives this data and closes the third PAV 240 and the second PAV 215. Using the Ideal Gas Law, the drop in pressure within the HG pressure vessel 212 corresponds to a predetermined quantity of gas delivered to the blade 100.

Once the predetermined quantity of HG is delivered to the blade 100, the pressure drops to 345 kPa (50 psi), and the third PAV 240 is closed, the fourth PAV 241 is opened to deliver CG at 50° C. (122° F.) to the blade 100. Here again, once the pressure within the CG pressure vessel 213 drops to 345 kPa (50 psi) from its initial setting of 552 kPa (80 psi) indicating the predetermined quantity of CG has been delivered, the PLC 261 receives this data from the second pressure sensor 234 and closes the fourth PAV 241. Even though the CG is at a temperature where common flow meters may be utilized, the principles of the Ideal Gas Law is applied to determine the quantity of gas delivered eliminating the need for added complexity and providing symmetry to the inspection system 200.

In one embodiment, when the third PAV 240 is closed after delivery of HG, the PLC 261 opens the first PAV 214 allowing ambient gas 202 to flow through the HG charge line 210. The ambient gas 202 flows through the first CV 216 and the HG pressure vessel inlet 218 on a HG pressure vessel cover plate 219 to refill the HG pressure vessel 212. As will be described further below, the ambient gas 202 flows through the first heat exchanger 305 (shown in FIG. 3) and refills the HG pressure vessel 212 at the predetermined temperature of 400° C. (752° F.). Once the pressure within the HG pressure vessel 212 increases back up to 552 kPa (80 psi), the PLC 261 closes the first PAV 214. The rate at which the HG pressure vessel 212 is filled may be predetermined based at least upon time required for change-out of the blade 100, such as, but not limited to, 0.1 kg of gas per in 60 seconds.

Additionally, once the fourth PAV 241 is closed after delivering the predetermined quantity of CG, the PLC 261 opens the second PAV 215 allowing ambient gas 202 to flow through the CG charge line 211. As described in connection with refilling the HG pressure vessel 212, the ambient gas 202 flowing through the CG charge line 211 refills the CG pressure vessel 213 until the pressure within the CG pressure vessel 213 is elevated back to the initial setting of 552 kPa (80 psi). The rate at which the CG pressure vessel 213 is filled may be identical to the HG pressure vessel 212 fill rate. However, the CG is at the lower temperature of 50° C. (122° F.).

In a preferred embodiment, at no time are any two of the PAVs 214-215 & 240-241 opened at the same time; however, it should be appreciated that alternating PAVs 214-215 & 240-241 are opened and closed in a rapid manner to provide constant initial settings for subsequent inspections.

As a result, the infrared (IR) inspection system 200 facilitates delivery of gases with a high thermal differential at precisely controlled temperatures.

Here again, the symmetry of the inspection system 200 is illustrated in that identical components may be utilized for both of the pressure vessels 212 & 213 for gases at two different temperatures.

During a prolonged inspection cycle where the inspection system 200 is not used, the inspection system 200 facilitates delivery of gases with a high thermal differential at precisely controlled temperatures, independent of the inspection cycle, in accordance with one embodiment of the present invention. If the inspection system 200 is not used for a period, the principles of heat transfer would change the temperatures of the gases. However, the present invention takes into account the heat transfer principles to ensure that the temperatures of the gases are maintained and ready for use at all times.

FIG. 3 illustrates a pressure vessel with its internal components, in accordance with one embodiment of the present invention. Shown in FIG. 3 is a pressure vessel that is representative of both the HG pressure vessel 212 and the CG pressure vessel 213. As previously described, except for the two different temperatures, 400° C. (752° F.) and 50° C. (122° F.), the components of both of the pressures vessels 212 & 213 are identical. Accordingly, in order to describe the invention, references will be made to one illustration of a pressure vessel. Furthermore, because of the symmetry of the inspection system 200, in particular, the pressure vessels 212 & 213, the internal components of the pressure vessel shown in FIG. 3 apply to both of the pressure vessels 212 & 213.

Shown in FIG. 3, incorporated in the electric heater 220 & 223 is a first temperature sensor 301 & 331 to measure the temperature of the electric heater 220 & 223 and transmit this data to the PLC 261. The electric heater 220 & 223 is used to heat the heat exchanger 305 & 306. As shown in FIG. 3, the heat exchanger 305 receives the ambient gas 202 at an inlet 310 located at one end of the heat exchanger 305 and discharges gas at the predetermined temperatures at an outlet 311 located at the opposite end of the inlet 310. As the ambient gas 202 flows through the heat exchanger 305 & 306, the ambient gas 202 is heated to the predetermined temperatures of 400° C. (752° F.) and 50° C. (122° F.) respectively depending upon the appropriate pressure vessel (i.e., HG or CG pressure vessels 212 & 213). In order to precisely control the gas temperatures, a second temperature sensor 302 & 304 measures temperature of the heat exchanger 305 & 306 and a third temperature sensor 303 & 333 measures the temperature of the gas at the outlet 311 & 312. The data from the temperature sensors 301 & 331, 302 & 304, and 303 & 333 may be transmitted to the PLC 261 via the control lines 270 & 271 connecting the PLC 261 to the first and second electric heaters 220 & 223.

If gas is allowed to loose its predetermined temperature (i.e., an inspection is not performed for a prolonged period of time), the third temperature sensor 311 measures the reduction in temperature and transmits the data to the PLC 261. The PLC 261 opens the solenoid valve 235 & 236 to release pressure within the pressure vessel 212 & 213. Once the pressure drops to 345 kPa (50 psi), as measured by the pressure sensor 233 & 234 on the pressure vessel 212 & 213, the PLC 261 proceeds to refill the pressure vessel 212 & 213 as described above. Accordingly, gas enters pressure vessels 212 & 213 through heat exchangers 305 & 306 at predetermined temperatures, thereby precisely controlling the temperatures of gas within pressure vessels 212 & 213.

Additionally, because pressures temperatures of the system 200 may be very high and vary, each of the pressure vessels 212 & 213 are fitted with a rupture disk 290 & 291. The rupture disk may be any type of rupture disk to prevent catastrophic failure of the pressure vessels 212 & 213, such as, but not limited to, graphite rupture disks.

In one embodiment, heat exchanger 305 & 306 is the improved heat exchanger disclosed in co-pending U.S. patent application Ser. No. ______, titled “HEAT EXCHANGER TO FACILITATE ACCURATE TEMPERATURE CONTROL”, contemporaneously filed and having at least partial common inventorship with the present application. The application is hereby fully incorporated by reference.

While the present invention has been described with regard to inspection of gas turbine blades 100 (shown in FIG. 1), it should be appreciated by those skilled in the art that present invention may be practiced to detect defects in any type of internal and/or external features utilizing IR detection methods. Different embodiments and adaptations besides those shown and described herein, as well as many variations, modifications and equivalent arrangements will now be apparent or will be reasonably suggested by the foregoing specification and drawings, without departing from the substance or spirit and scope of the invention. While the present invention has been described herein in detail in addition to its preferred embodiment, it is to be understood that this disclosure is only illustrative and exemplary of the present invention and is made merely for purposes of providing a full an enabling disclosure of the invention.

Thus, an infrared (IR) inspection system that facilitates delivery of gases with a high thermal differential at precisely controlled temperatures, independent of the inspection cycle, has been disclosed.

What is claimed is:

1. An apparatus comprising:
a first pressure vessel to store and maintain a first fluid at a first temperature and pressure;
a second pressure vessel to store and maintain a second fluid at a second temperature and pressure;
a first fluid delivery line coupled to the first pressure vessel;
a second fluid delivery line coupled to the second pressure vessel;
a first pneumatically actuated valve coupled to the first fluid delivery line;
a second pneumatically actuated valve coupled to the second fluid delivery line, wherein the first and second pneumatically actuated valves facilitate alternating delivery of the fluid from the first and second pressure vessels;
an inspection fluid delivery line coupled to first and second pneumatically actuated valves to deliver the alternating fluid to a turbine component;
a plurality of sensors coupled to the first and second pressure vessels to detect changes in temperature and pressure of the first and second fluids; and
a programmable logic control (PLC) connected to the plurality of sensors to facilitate the first pressure vessel to store and maintain the first fluid at the first temperature and pressure and the second pressure vessel to store and maintain the second fluid at the second temperature and pressure.

2. The apparatus of claim 1 further comprising an ambient temperature pressure vessel coupled to the first and second pneumatically actuated valves to facilitate opening and closing of the first and second pneumatically actuated valves.

3. The apparatus of claim 1, wherein the turbine component is a selected one of a turbine blade and a turbine blade.

4. The apparatus of claim 1, wherein the first pressure vessel includes a first internal heat exchanger.

5. The apparatus of claim 1, wherein the second pressure vessel includes a second internal heat exchanger.

6. The apparatus of claim 1, wherein the first temperature is 400° C. (752° F.).

7. The apparatus of claim 1, wherein the second temperature is 50 ° C. (122° F.).

8. The apparatus of claim 1, wherein the first and second fluids is air.

9. The apparatus of claim 1, wherein the PLC comprises a PLC having fuzzy logic programming.

10. The apparatus of claim 1, wherein the first and second pressure vessels include a first and second rupture disk, respectively.

11. The apparatus of claim 1, the PLC comprises a PLC utilizing the Ideal Gas Law to determine the first and second temperature and pressure.

12. The apparatus of claim 1 further comprising:
a first wire heater wrapped around the first fluid delivery line; and
a second wire heater wrapped around the second fluid delivery line, wherein the first and second wire heaters facilitate maintaining the first and second temperature and pressure of the first and second fluids delivered by the first and second delivery lines.

13. A turbine component inspection apparatus utilizing fluids at different temperatures and pressures, comprising:
a first pressure vessel to store and maintain a first fluid at a first temperature and pressure;
a second pressure vessel to store and maintain a second fluid at a second temperature and pressure;
means for delivering the first fluid from the first pressure vessel at the first temperature and pressure and the second fluid from the second pressure vessel at the second temperature and pressure to a turbine component;
means for detecting changes in temperature and pressure of the first and second fluids; and
means for storing and maintaining in the first pressure vessel, the first fluid at the first temperature and pressure and in the second pressure vessel, storing and maintaining the second fluid at the second temperature and pressure.

14. The gas turbine inspection system of claim 13, wherein the means for delivering the first and second fluid comprises means for facilitating opening and closing of a first and second pneumatically actuated valves.

15. The gas turbine inspection system of claim 13, wherein the means for storing and maintaining comprises means for including a heat exchanger within the first and second pressure vessels.

16. The gas turbine inspection system of claim 13, wherein the means for detecting changes in temperature and pressure comprises means for utilizing temperature and pressure sensors with the gas turbine inspection system.
